(19) United States
(12) Patent Application Publication
(10) Pub. No.: US 2026/0016154 A1
(43) Pub. Date: Jan. 15, 2026

(54) Liquid Candle and a Liquid Candle Combined Device

(71) Applicant: Ningbo Kwung's Wisdom Art & Design Co., Ltd., Ningbo, Zhejiang (CN)

(72) Inventors: Jianxin Jin, Ningbo (CN); Hongjian Tu, Ningbo (CN); Jinlin Wang, Ningbo (CN)

(21) Appl. No.: 19/005,193

(22) Filed: Dec. 30, 2024

(30) Foreign Application Priority Data
Jul. 12, 2024 (CN) 202410937545.9

(51) Int. Cl. F21V 37/00; F21V 35/00

(52) U.S. Cl. CPC F21V 37/002; F21V 35/00; F21V 37/0008

(57) ABSTRACT

A liquid candle and a liquid candle combined device. The liquid candle has a lamp tube having a mounting chamber running through the lamp tube vertically; and a wick vertically disposed inside the mounting chamber of the lamp tube. The lamp tube has at least two through holes distributed at intervals on a peripheral wall of the lamp tube and radially running through the peripheral wall of the lamp tube. Due to the arrangement of the through holes, when the liquid candle does not burn, the liquid candle can serve as a volatile aromatherapy stick to spread fragrance through the through holes and the top tube opening of the lamp tube. When the liquid candle is burning, heat is dissipated through the through holes, prolonging the service life of the lamp tube.

### TECHNICAL FIELD OF THE INVENTION

The present invention relates to a field of candles, and in particular to a liquid candle and a liquid candle combined device.

### BACKGROUND OF THE INVENTION

Candles are a kind of daily lighting tools. As traditional lighting products, candles have a long history and are often used in birthday parties, religious festivals and other activities.

Common candles are solid candles. The fuel of solid candles is solid, mainly made of paraffin, and added with auxiliary materials such as white oil, stearic acid, polyethylene and essence. The solid candles can be manufactured into various shapes of craft candles.

In addition, candles also comprise liquid candles. The fuel of liquid candles is liquid, which is also called lamp oil. A wick of the liquid candle absorbs the lamp oil from a bottom end to a top end of the wick, and the top end of the wick is ignited for burning. For example, a Chinese patent CN2673871Y disclosed an artistic colored liquid candle; and a Chinese patent application CN105593355A disclosed a liquid candle system.

However, the existing liquid candles still have some problems in the actual application process, for example, the single function of the liquid candle, the poor service life of the lamp tube, the unsatisfactory absorption effect of the wick on the lamp oil, etc.

### SUMMARY OF THE INVENTION

It is a first object of the present invention to provide a liquid candle, which can also serve as an aromatherapy volatile stick, and has rich functions.

It is a second object of the present invention to provide a liquid candle which has longer service life.

It is a third object of the present invention to provide a liquid candle which has a satisfactory absorption effect of the wick on the lamp oil.

It is a fourth object of the present invention to provide a liquid candle combined device.

For achieving the first object, the liquid candle comprises a lamp tube having a mounting chamber running through the lamp tube vertically; and
a wick vertically disposed inside the mounting chamber of the lamp tube;
wherein,
the lamp tube has at least two through holes distributed at intervals on a peripheral wall of the lamp tube and radially running through the peripheral wall of the lamp tube.

For achieving the second object, preferably, the lamp tube comprises an upper lamp tube having a bottom and a lower lamp tube being connected to the bottom of the upper lamp tube;
the upper lamp tube and the lower lamp tube are made of different materials, and a heat dissipation speed of the upper lamp tube is greater than that of the lower lamp tube.

Under such design, the lamp tube has the following functions. Firstly, considering high temperature of a top flame when the liquid candle is burning, the upper lamp tube also has high temperature since it is close to the top flame. If the upper lamp tube is made of a material with fast heat dissipation, it is advantageous for heat dissipation, and the upper lamp tube is difficult to age, so that the service life of the lamp tube is prolonged. Secondly, during production, the upper lamp tube and the lower lamp tube can be produced separately and then assembled, thereby reducing the requirements for production materials and production devices and facilitating manufacturing of the products.

The upper lamp tube and the lower lamp tube can be connected in different ways. Preferably, the lower lamp tube has a lower mounting chamber running through the lower lamp tube vertically;
the upper lamp tube has an extension extending downward from the bottom of the upper lamp tube and positioning inside the lower mounting chamber, the extension is in threaded connection to a wall of the lower lamp tube; the upper lamp tube has an upper mounting chamber running through the upper lamp tube and the extension vertically, the upper mounting chamber communicates with the lower mounting chamber and together are defined as the mounting chamber.

Under such design, the connecting structure between the upper lamp tube and the lower lamp tube has the following three functions. Firstly, by adopting threaded connection, it is easy to disassemble and assemble the upper lamp tube and the lower lamp tube. Secondly, by using the extension for insertion, the inner diameter of at least part of the upper mounting chamber is smaller than that of the lower mounting chamber, so that it is convenient for the wick to be positioned inside of the upper mounting chamber. Thirdly, when the liquid candle needs to maintained after use for a period of time, it is only necessary to replace the upper lamp tube or the lower lamp tube, and the remaining body can be continuously used, thereby saving cost for replacement.

Alternatively, the upper lamp tube and the lower lamp tube can also be connected by bonding, magnetic attraction, etc.

For achieving the third object, preferably, the wick having an upper portion and a lower portion comprises at least two cords; in the upper portion of the wick, the at least two cords are wound and woven together; in the lower portion of the wick, the at least two cords are distributed at intervals without being wound and woven together.

Thus, such design has the following three functions. Firstly, the liquid candle has a certain height, so it is a difficult problem how the wick well absorbs the lamp oil. The effect of absorbing the lamp oil by the wick will affect the ignition effect of the liquid candle. If the lamp oil is thick, the lamp oil is difficult to be absorbed by the wick; and if the lamp oil is thin, the lamp oil is easy to fall under the action of gravity and not easy to reach the top end of the wick. Since the cords in the lower portion of the wick are fluffy without being wound and woven, the lamp oil can be well absorbed by the wick, and it is convenient to ignite the liquid candle. Thus, even if the lamp oil is thin, the lamp oil is difficult to slip from the wick to affect the ignition effect of the wick. Secondly, since the cords in the upper portion of the wick are wound and woven, during mounting, the whole wick can be taken up by the user by holding the upper portion of the wick, so that it is convenient for the user's operation. In addition, when the position of the wick in a gravity direction needs to be further adjusted after the wick is preassembled in the lamp tube, the user can also act on the upper portion of the wick to realize adjustment. Thirdly, since the cords in the upper portion of the wick are wound and woven and thus relatively centralized, the flame is relatively centralized after the liquid candle is ignited. Thus, the design requirements for oil absorption of the wick, mounting of the wick and the flame are all taken into consideration.

In order to facilitate the lamp oil to enter the lamp tube and limit the wick, the lamp tube has a top tube opening and a bottom tube opening, and a diameter of the bottom tube opening is greater than that of the top tube opening. Thus, since the diameter of the bottom tube opening of the lamp tube is larger, it is convenient for the lamp oil to enter the lamp tube, and it is convenient for the wick to absorb the lamp oil. Moreover, since the diameter of the top tube opening is smaller, it is convenient to limit the wick.

Preferably, the wick has a top and a bottom, the top of the wick or/and the bottom of the wick extend(s) out of the lamp tube.

By extending the top of the wick out of the lamp tube, the following functions are realized. Firstly, the wick is easy to be carbonized when burning, but it is difficult to handle the carbonized wick in the lamp tube, so it is convenient to handle the carbonized wick if the wick extends out of the lamp tube. Secondly, by extending the wick out of the lamp tube, it is convenient to adjust the flame size. Thirdly, it is beneficial for fragrance diffusion. Fourthly, the liquid candle has a shape similar to the solid candle, and is relatively aesthetic.

By extending the bottom out of the wick, the following functions are realized. Firstly, it is convenient to absorb the lamp oil. Secondly, it is convenient to increase the function on a bottom of the container for accommodating the liquid candle, and it is convenient to maintain the lamp tube at a desired position. Thirdly, an upper end of the lamp tube appears higher, and the liquid candle appears higher.

In order to simulate a height of a common candle, preferably, the lamp tube has a length of 30 millimeter to 350 millimeter.

In order to observe the mounting of the wick, preferably, the lamp tube is made of a transparent material.

For achieving the fourth object, the liquid candle combined device having the above-stated liquid candle comprises:
a container having a chamber which is filled with a lamp oil inside the container and an opening at a top of the container;
the liquid candle is inserted into the chamber from the opening at the top of the container, and a bottom of the wick is immersed into the lamp oil.

In order to observe the remaining amount of the lamp oil from the outside of the container, preferably, the container is made of a transparent material.

Compared with the prior art, the liquid candle of the present invention has the following advantages. Since each lamp tube has the plurality of through holes on the peripheral wall of the lamp tube, when the liquid candle does not burn, the liquid candle can serve as the aromatherapy volatile stick to spread fragrance through the through holes and the top tube opening of the lamp tube, so that the liquid candle has more functions. When the liquid candle is burning, heat is dissipated through the through holes, so that the service life of the lamp tube can be prolonged. If the lamp oil contains a fragrance substance, the fragrance will also be spread through the through holes. The liquid candle combined device of the present invention also has the above said advantages.

### BRIEF DESCRIPTION OF THE DRAWINGS

FIG. 1 is a view of a liquid candle combined device according to Embodiment 1 of the present invention;

FIG. 2 is a front view of a liquid candle according to Embodiment 1 of the present invention;

FIG. 3 is a perspective view of a lamp tube according to Embodiment 1 of the present invention;

FIG. 4 is a perspective view of a lamp tube according to Embodiment 2 of the present invention.

### DETAILED DESCRIPTION OF THE INVENTION

The present invention will be further described below in detail by embodiments with reference to the accompanying drawings.

### Embodiment 1

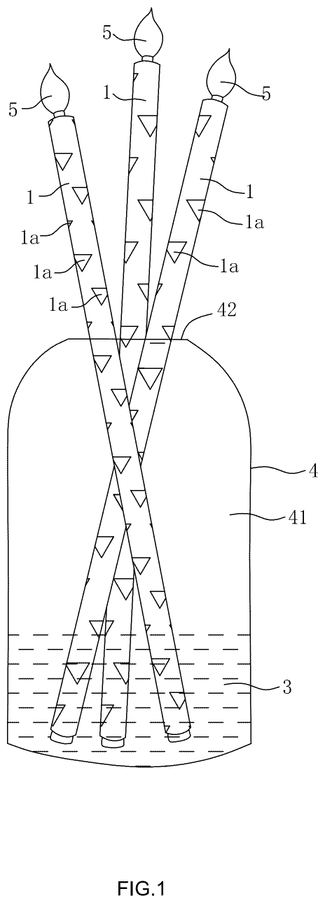

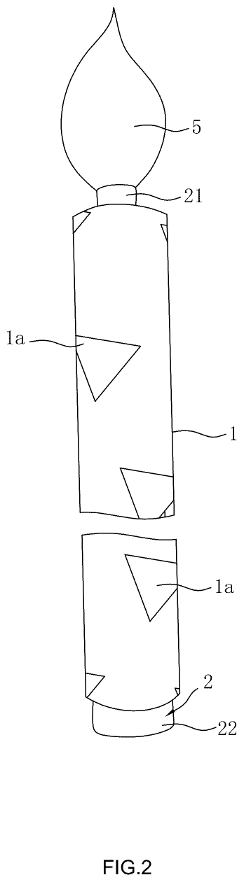

FIGS. 1-3 show a preferred Embodiment 1 of a liquid candle combined device with one or more liquid candles of the present invention. The liquid candle comprises a lamp tube 1 and a wick 2.

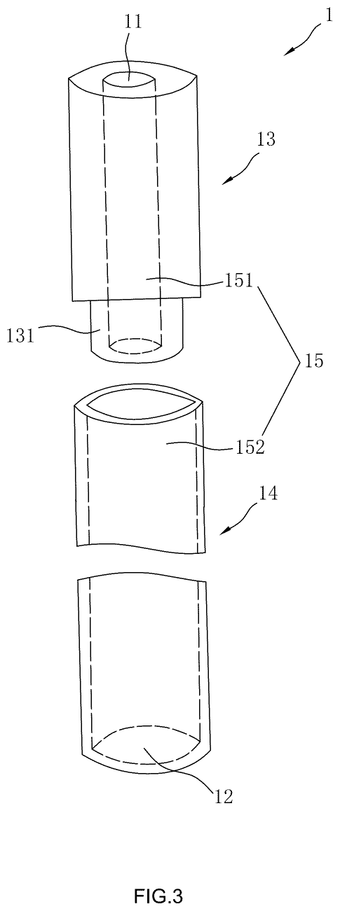

The lamp tube 1 has a mounting chamber 15 running through the lamp tube 1 vertically and a plurality of through holes la distributed at intervals on a peripheral wall of the lamp tube 1 and radially running through the peripheral wall of the lamp tube 1. The shape for example, triangular, circular, rectangular, etc. and number of the through holes la can be adjusted as required. The lamp tube 1 has a top tube opening 11 and a bottom tube opening 12, and a diameter of the bottom tube opening 12 is greater than that of the top tube opening 11. The lamp tube 1 has a length of 30 millimeter to 350 millimeter. Referring to FIG. 3, in order to illustrate the internal structure of the lamp tube 1 more clearly, the through holes la are not shown in the FIG. 3. The lamp tube 1 comprises an upper lamp tube 13 having a bottom and a lower lamp tube 14 being connected to the bottom of the upper lamp tube 13. Specifically, the lower lamp tube 14 has a lower mounting chamber 152 running through the lower lamp tube 14 vertically. The upper lamp tube 13 has an extension 131 extending downward from the bottom of the upper lamp tube 13 and positioning inside the lower mounting chamber 152. The extension 131 is in threaded connection to a wall of the lower lamp tube 14. The upper lamp tube 13 has an upper mounting chamber 151 running through the upper lamp tube 13 and the extension 131 vertically. The upper mounting chamber 151 communicates with the lower mounting chamber 152 and together are defined as the mounting chamber 15. The lamp tube 1 may be made of a non-transparent material, or may be made of a transparent material, for example, being made of a single material, for example, metal, glass, ceramics, plastics, etc., or a combination of two or more of these materials. The transparent material may also be colored and transparent. Preferably, the upper lamp tube 13 and the lower lamp tube 14 are made of different materials, and a heat dissipation speed of the upper lamp tube 13 is greater than that of the lower lamp tube 14. For example, the upper lamp tube 13 is made of high-temperature-resistant brass or aluminum alloy, while the lower lamp tube 14 is made of plastics, so that it is advantageous to reduce the amount of metal materials and the production cost. Further, the peripheral wall of the lamp tube 1 may be coated with a heat-resistant coating, or thermal insulating materials such as a nanopore insulating material are added in the lamp tube 1.

The wick 2 is vertically disposed inside the mounting chamber 15 of the lamp tube 1. The wick 2 has a plurality of cords. The number of the cords is adjusted as required. The wick 2 has an upper portion and a lower portion, in the upper portion of the wick 2, the at least two cords are wound and woven together; and in the lower portion of the wick 2, the at least two cords are distributed at intervals without being wound and woven together. The wick 2 has a top 21 and a bottom 22, the top 21 of the wick 2 and the bottom 22 of the wick 2 extend out of the lamp tube 1. The wick 2 is made of glass fiber or silicon dioxide. The top 21 of the wick 2 is ignited to form a flame 5.

FIG. 1 shows a preferred embodiment of a liquid candle combined device of the present invention. The liquid candle combined device comprises one or more liquid candles described above and a container 4. The container has a chamber 41 which has lamp oil 3 filled inside the container 4 and an opening 42 at a top of the container 4. Each liquid candle is inserted into the chamber 41 from the opening 42 of the container 4, and the bottom 22 of the wick 2 is immersed into the lamp oil 3. The container 4 is preferably made of a transparent material, and may also be made of other materials. The lamp oil 3 is preferably formulated with a fragrance substance, thereby spreading fragrance.

The operation process of the liquid candle combined device will be described below.

The wick 2 of each liquid candle is preassembled in the lamp tube 1, and the user can move the top 21 of the wick 2 to adjust the position of the wick 2.

The lamp oil 3 is poured into the container 4, the lamp tube 1 is inserted into the container 4, so as to make the bottom 22 of the wick 2 immersed into the lamp oil 3, and the wick 2 of each liquid candle absorbs the lamp oil 3 up. When lighting is required, the user ignites the top 21 of the wick 2. The lamp tube 1 is equivalent to the main body of the candle because the lamp tube 1 will not be burnt. When the liquid candle is burning, heat and fragrance are diffused through the plurality of through holes la of the lamp tube 1.

When the liquid candle does not burn, the lamp tube 1 also serves as an aromatherapy volatile stick, and fragrance is spread through the top tube opening 11 and the through holes la of the lamp tube 1.

### Embodiment 2

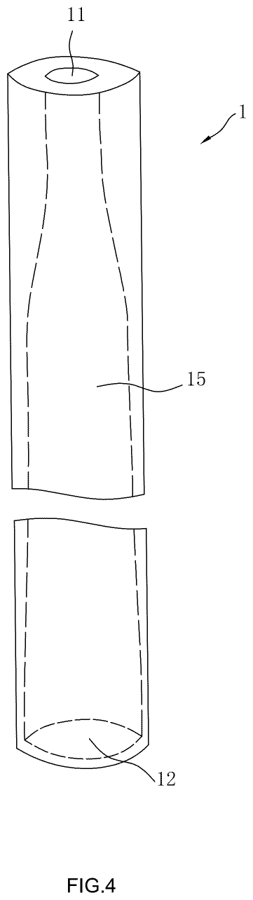

As shown in FIG. 4, the structure of the liquid candle in this embodiment is basically the same as that in Embodiment 1, the difference is the structure of the lamp tube 1. Referring to FIG. 4, the lamp tube 1 is an integral part, and from the top down, there is a smooth transition between a small diameter of a top tube opening and a large diameter of a bottom tube opening of the lamp tube 1.

1. A liquid candle, comprising:
a lamp tube (1) having a mounting chamber (15) running through the lamp tube (1) vertically; and
a wick (2) vertically disposed inside the mounting chamber (15) of the lamp tube (1);
wherein,
the lamp tube (1) has at least two through holes (la) distributed at intervals on a peripheral wall of the lamp tube (1) and radially running through the peripheral wall of the lamp tube (1).

2. The liquid candle of claim 1, wherein the lamp tube (1) comprises an upper lamp tube (13) having a bottom and a lower lamp tube (14) being connected to the bottom of the upper lamp tube (13);
the upper lamp tube (13) and the lower lamp tube (14) are made of different materials, and a heat dissipation speed of the upper lamp tube (13) is greater than that of the lower lamp tube (14).

3. The liquid candle of claim 2, wherein the lower lamp tube (14) has a lower mounting chamber (152) running through the lower lamp tube (14) vertically;
the upper lamp tube (13) has an extension (131) extending downward from the bottom of the upper lamp tube (13) and positioning inside the lower mounting chamber (152), the extension (131) is in threaded connection to a wall of the lower lamp tube (14);
the upper lamp tube (13) has an upper mounting chamber (151) running through the upper lamp tube (13) and the extension (131) vertically, the upper mounting chamber (151) communicates with the lower mounting chamber (152) and together are defined as the mounting chamber (15).

4. The liquid candle of claim 1, wherein the wick (2) having an upper portion and a lower portion comprises at least two cords;
in the upper portion of the wick (2), the at least two cords are wound and woven together;
in the lower portion of the wick (2), the at least two cords are distributed at intervals without being wound and woven together.

5. The liquid candle of claim 1, wherein the lamp tube (1) has a top tube opening (11) and a bottom tube opening (12), and a diameter of the bottom tube opening (12) is greater than that of the top tube opening (11).

6. The liquid candle of claim 1, wherein the wick (2) has a top (21) and a bottom (22), the top (21) of the wick (2) or/and the bottom (22) of the wick (2) extend(s) out of the lamp tube (1).

7. The liquid candle of claim 1, wherein the lamp tube (1) has a length of 30 millimeter to 350 millimeter.

8. The liquid candle of claim 1, wherein the lamp tube (1) is made of a transparent material.

9. A liquid candle combined device having the liquid candle of claim 1 comprises:
a container (4) having a chamber (41) which is filled with a lamp oil (3) inside the container (4) and an opening (42) at a top of the container (4);
the liquid candle is inserted into the chamber (41) from the opening (42) at the top of the container (4), and a bottom (22) of the wick (2) is immersed into the lamp oil (3).

10. The liquid candle combined device of claim 9, wherein the container (4) is made of a transparent material.
